(19) United States
(12) Patent Application Publication
(10) Pub. No.: US 2021/0383116 A1
(43) Pub. Date: Dec. 9, 2021

(54) AUGMENTED REALITY SYSTEM AND METHOD

(71) Applicant: AMADEUS S.A.S., Biot (FR)

(72) Inventors: John MAVRANTONAKIS, London (GB); Gian NTZIK, London (GB); Sawan KAPAI HARPALANI, London (GB); Anne-Lise AMIOT, London (GB)

(21) Appl. No.: 17/284,260

(22) PCT Filed: Oct. 15, 2019
(86) PCT No.: PCT/EP2019/077906

§ 371 Date: Apr. 9, 2021

(30) Foreign Application Priority Data
Oct. 15, 2018 (FR) 1859511

(51) Int. Cl. G06K 9/00; G06F 3/01; G06F 3/16; G06T 19/00

(52) U.S. Cl. CPC G06K 9/00671; G06F 3/011; G06T 19/006; G06F 3/167; G06T 19/003; G06F 3/017

(57) ABSTRACT

An augmented reality computing device, hereinafter referred to as the AR device, comprising one or more processors configured to receive information relating to a moveable object, check whether a virtual representation of the object forms part of a virtual representation of the environment occupied by the AR device and display, in a user observable display portion of the AR device information relating to the object.

### FIELD

Embodiments described herein relate generally to augmented reality systems and methods and in particular to a system and associated methods of improved object handling with the aid of augmented reality systems, devices and methods.

### BACKGROUND

The increasing availability of data and data sources in the modern world has driven increase and innovation in the ways that people consume data. Individuals increasingly rely on online resources and the availability of data to inform their daily behaviour and interactions. The ubiquity of portable, connected devices has allowed for the access of this type of information from almost anywhere.

The use of this information to augment the visual world, however, remains in its infancy. Current augmented reality systems can overlay visual data on a screen or viewport providing information overlaid onto the visual world. Although useful, these types of systems are usually limited to simply providing an additional display for information already available to a user or replicate the visual spectrum with overlaid data. There is a need for truly augmented systems that use contextual information and details about the visual perception of a user to provide a fully integrated, augmented reality experience.

### BRIEF DESCRIPTION OF THE DRAWINGS

The present invention will be understood and appreciated more fully from the following detailed description taken in conjunction with drawings in which:

FIG. 1 is a block diagram of an exemplary augmented reality system of an embodiment;

FIG. 2 is a block diagram of a computing device for use in an embodiment;

FIG. 3A shows a block diagram of an augmented reality device for use in an embodiment;

FIG. 3B shows an example of an augmented reality device for use in an embodiment;

FIG. 4 shows a basic flow chart for a method for locating objects:

FIG. 5 shows a basic flow chart for a method of displaying information in an AR device;

FIG. 6 shows an example of an augmented reality display that may be presented to a user;

FIG. 7 shows a basic flowchart for a method of searching for objects; and

FIG. 8 shows a basic flowchart for a method in aiding in handling objects.

### DETAILED DESCRIPTION

Reference will now be made in detail to the exemplary embodiments implemented according to the present disclosure, the examples of which are illustrated in the accompanying drawings. Wherever possible, the same reference numbers will be used throughout the drawings to refer to the same or like parts.

In embodiments, there is provided a non-transitory computer readable storage medium storing instructions that are executable by an augmented reality computing system, hereinafter referred to as AR system. The AR system includes one or more processors. The instructions are such as to cause the system to perform a method of determining the location of uniquely identifiable objects. The method comprises generating a three dimensional virtual model of at least a part of an environment surrounding the AR system based on information provided by sensors of the AR system, detecting a unique identifier of an object within the environment using said sensors and determining a location of the object within the three dimensional model.

The system may be an augmented reality device that can establish a communicative connection with a computing environment. In this embodiment information relating to the location of the object within the three dimensional model may be transmitted to the computing environment for further use, say via a wireless data communication connection as may be established in the context of an ad hoc network.

In an alternative embodiment, the system includes both the augmented reality device and a computing environment with which the augmented reality device is in communicative contact. In this alternative embodiment the information relating to the absolute location of the object within the three dimensional model may also be transmitted to the computing environment but it is appreciated that such a transfer is within the AR system for further, internal or external use.

In an embodiment, the method may further comprise retrieving stored information relating to a uniquely identified object and displaying at least part of the stored information in a user observable display portion of the AR system.

In an embodiment, the information can be presented in the display portion so that it is clearly associated with or overlaid over the view of the object when the object is within the field of view (FOV) of the AR system as observable by the user of the AR system.

In an embodiment the method further comprises, when the object is not within the FOV of the AR system as observable by the user of the AR system, determining a route within the virtual model that allows the user of the AR system to move toward the object and displaying the route within the FOV of the AR system as observable by the user of the AR system.

In an embodiment the method further comprises detecting an identifier that has a known absolute real-world position within the environment surrounding the AR system and referencing the positions of objects within the virtual model to the identifier having a known absolute real-world position, thereby associating an absolute real world position to the objects.

According to an embodiment, there is provided a non-transitory computer readable storage medium storing instructions that are executable by an augmented reality computing device, hereinafter referred to as the AR device, that includes one or more processors. The instructions such as to cause the AR device to perform a method of displaying object information. The method comprises receiving information relating to a moveable object, checking whether a virtual representation of the object forms part of a virtual representation of the environment occupied by the AR device and displaying, in a user observable display portion of the AR device, information relating to the object.

In an embodiment, the virtual representation may be stored on the AR device.

In an embodiment, the method further comprises, when the object is not within the FOV of the AR device as observable by the user of the AR device, determining a route within the virtual model that allows the user of the AR device to move toward the object and displaying the route within the FOV of the AR device as observable by the user of the AR device.

In an embodiment, the information is presented in the display portion so that it is clearly associated with or overlaid over the view of the object when the object is within the FOV of the AR device as observable by the user of the AR device.

In an embodiment, the method further comprises receiving an indication from a user of the AR device of an operating mode or one or more information selection criteria and operating the AR device in an operating mode identified by a received indication or filtering the received information according to a received indication of the one or more information selection criteria.

In an embodiment, the method further comprises receiving said indication by one or more of detecting and interpreting a voice command provided by the user, detecting and interpreting one or more user gestures using sensors of the AR device or detecting and interpreting a region of a display of the AR device or an object currently observed by the user of the AR device.

In an embodiment, there is provided a non-transitory computer readable storage medium storing instructions that are executable by a computing system, that includes one or more processors, the instructions configured to cause the system to transmit, to one or more AR devices that are in communicative connection with the computing system, information relating to an object, wherein the information comprises a unique object identifier and object handling information.

In an embodiment the method further comprises determining, based on information stored in the computing system, a last known location of the object and selectively transmitting said information only to one or more of the one or more AR devices that are known to be in a vicinity of the last known location of the object.

The AR device may be deemed to be in the vicinity of the last known location if the AR device is in the room in which the object is known to have last been located or if the AR device is within a predetermined distance from the last known location of the object.

In an embodiment, the method further comprises receiving, from an AR device location information of a uniquely identifiable object and one or more of storing said location information in a memory device of the system or forwarding said information or part thereof to one or more other AR devices of the one or more AR devices.

According to an embodiment, there is provided a method of determining the location of uniquely identifiable objects performed by an augmented reality computing system, hereinafter referred to as AR system that includes one or more processors. The method comprises generating a three dimensional virtual model of at least a part of an environment surrounding the AR system based on information provided by sensors of the AR system, detecting a unique identifier of an object within the environment using said sensors and determining an absolute location of the object within the three dimensional model.

According to an embodiment, there is provided a method of displaying object information performed by an augmented reality computing device, hereinafter referred to as the AR device, that includes one or more processors. The method comprising receiving information relating to a moveable object, checking whether a virtual representation of the object forms part of a virtual representation of the environment occupied by the AR device and displaying, in a user observable display portion of the AR device information relating to the object.

According to an embodiment, there is provided a communication method performed by a computer system. The method comprises transmitting, to one or more AR devices that are in communicative connection with the computing system, information relating to an object, wherein the information comprises a unique object identifier and object handling information.

According to another embodiment there is provided an augmented reality computing system, hereinafter referred to as AR system, comprising one or more processors configured to determine the location of uniquely identifiable objects by generating a three dimensional virtual model of at least a part of an environment surrounding the AR system based on information provided by sensors of the AR system, detecting a unique identifier of an object within the environment using said sensors and determining an absolute location of the object within the three dimensional model.

According to another embodiment, there is provided an augmented reality computing device, hereinafter referred to as the AR device, comprising one or more processors configured to receive information relating to a moveable object, check whether a virtual representation of the object forms part of a virtual representation of the environment occupied by the AR device and display, in a user observable display portion of the AR device information relating to the object.

According to another embodiment, there is provided a computing system comprising one or more processors configured to transmit, to one or more AR devices that are in communicative connection with the computing system, information relating to an object, wherein the information comprises a unique object identifier and object handling information.

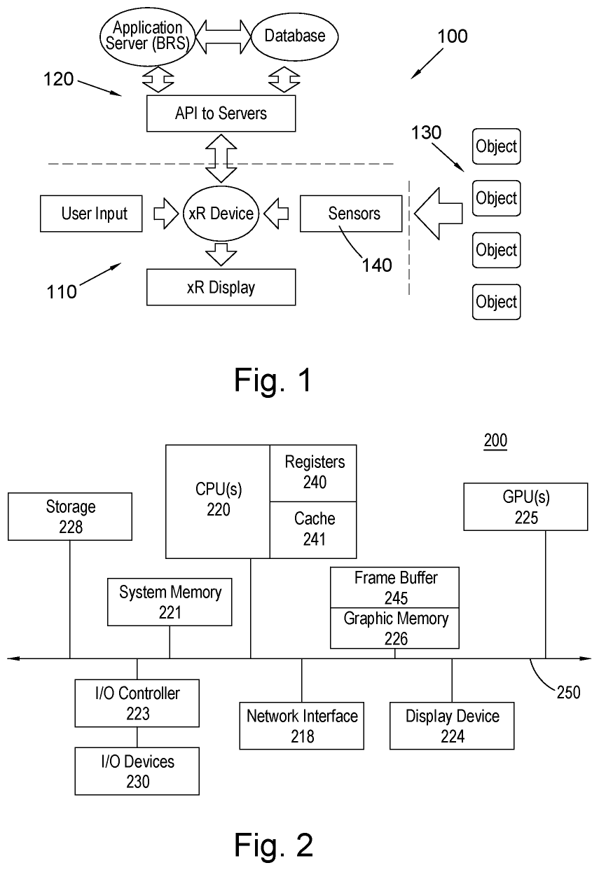

FIG. 1 is a block diagram of an augmented reality system 100 of an embodiment. The system 100 comprises a user subsystem 110 that interfaces with computing environment 120. In one embodiment at least parts of the user subsystem 110 are portable so that they can be taken by the user to an environment for sensing. The user subsystem 110 senses objects within the environment 130 in which it is used, creates a virtual representation or model of the environment and its components, including the objects located in the environment 130. The user subsystem 110 is in data connective contact with the computing environment 120 and exchanges data with it. This exchange can be one-way in either direction or two-way. The user subsystem 110 may, for example, send data related to objects identified in the process of creating the virtual representation of the environment of the user to the computing environment 120 to allow the computing environment 120 to update a database of the current locations of objects 130. Alternatively or additionally the computing environment 120 may transmit data regarding, inter alia, the identity of certain objects to the user device 110, for example to indicate to the user device 110 a list of objects that are currently considered lost and that users should try and find. As and when objects are found or handled in a particular manner, feedback to this effect can be provided by the user device 110 to the computing environment 120.

The computing environment comprises at least an application program interface to allow communicating between the user device 110 and the remainder of the computing environment 120, an application server for running applications for receiving and sending data from/to the user device 110 and a database in which such data, be that in the received form or in further processed form, are stored in/retrieved from. In an embodiment these applications include a geographical information system (GIS) that allows creating a map of the environment in which embodiments are to be used.

The database of computing environment 120 may include a number of databases and data sources. These databases my include databases that are proprietary to the operator of system 100 or to an operator of part of the system 100. A database or databases may, for example, be proprietary to an airport operator or to a flight operator. The computing system 120 may alternatively have access to external databases, such as a departure control system (DCS) database, baggage reconciliation systems (BRS) database, flight management (FM) database, customer management (CM) database, geospatial database, for example comprising maps and location data, baggage tracking databases (for example the worldtracer database) and databases holding regulatory data. Such external databases may, for example, include databases operated by flight operators. Such databases may provide data relating to flights that have newly arrived at an airport in which the computing system 120 is being operated in the embodiment and may transfer data relating to luggage carried on this flight to an airport database that stores information on the way luggage within the airport is to be handled. Alternatively or additionally data from a database of an operator handling luggage in an airport may be transferred to a non-proprietary database of an aircraft operator, for example to inform the aircraft operator of luggage loaded onto a particular flight and/or particular container to be loaded or loaded onto the flight.

Databases that are not integral with the computing environment 120 and that comment to the computing environment 120 via a data connection may, moreover, transmit individual pieces of data to the computing system. This may, for example, be the case in situations in which pieces of luggage that are deemed lost need to be selectively identified to the operators of the airport in which the piece of luggage may be (for example because they are suspected of or known to have handled the piece of luggage prior to the point of its suspected loss).

The user device 110 may be operated by the same entity that operates the computing environment 120. This can be the airport operator. Alternatively the user device 110 may be operated by a different entity, for example a contractor responsible for luggage handling within an airport. It will of course be appreciated that the system 100 can comprise more than one user device 110. In particular one user device 110 may be provided per human operator. Human operators may include luggage handlers as well as other airport ground staff, such as check in personnel. As such system 100 may include a large number of user devices. This number may be greater than 10 user devices for small operations but may exceed 100 user devices for larger operations.

The API can be implemented on a server or computer system using, for example, computing device 200, described in more detail below in reference to FIG. 2. For example, data from proprietary data sources and external data sources can be obtained through I/O devices 230 and/or network interface 218 of computing device 200. Further, the data can be stored during processing in a suitable storage such as storage 228 and/or system memory 221.

Like the API, the user system 110 can be implemented on a server or computer system using, for example, computing device 200.

FIG. 2 is a block diagram of an exemplary computing device 200, consistent with embodiments of the present disclosure. In some embodiments, computing device 200 can be a specialized server providing the functionality described herein. In some embodiments, components of system 100, such as proprietary data sources (e.g., databases, data sources, databases, and data system), API, user system 110 or parts thereof can be implemented using computing device 200 or multiple computing devices 200 operating in parallel. Further, computing device 200 can be a second device providing the functionality described herein or receiving information from a server to provide at least some of the described functionality. Moreover, computing device 200 can be an additional device or devices that store and/or provide data consistent with embodiments of the present disclosure.

Computing device 200 can include one or more central processing units (CPUs) 220 and system memory 221. Computing device 200 can also include one or more graphics processing units (GPUs) 225 and graphic memory 226. In some embodiments, computing device 200 can be a headless computing device that does not include GPU(s) 225 and/or graphics memory 226.

CPUs 220 can be single or multiple microprocessors, field-programmable gate arrays, or digital signal processors capable of executing sets of instructions stored in a memory (e.g., system memory 221), a cache (e.g., cache 241), or a register (e.g., one of registers 240). CPUs 220 can contain one or more registers (e.g., registers 240) for storing variable types of data including, inter alia, data, instructions, floating point values, conditional values, memory addresses for locations in memory (e.g., system memory 221 or graphic memory 226), pointers and counters. CPU registers 240 can include special purpose registers used to store data associated with executing instructions such as an instruction pointer, instruction counter, and/or memory stack pointer. System memory 221 can include a tangible and/or non-transitory computer-readable medium, such as a flexible disk, a hard disk, a compact disk read-only memory (CD-ROM), magneto-optical (MO) drive, digital versatile disk random-access memory (DVD-RAM), a solid-state disk (SSD), a flash drive and/or flash memory, processor cache, memory register, or a semiconductor memory. System memory 221 can be one or more memory chips capable of storing data and allowing direct access by CPUs 220. System memory 221 can be any type of random access memory (RAM), or other available memory chip capable of operating as described herein.

CPUs 220 can communicate with system memory 221 via a system interface 250, sometimes referred to as a bus. In embodiments that include GPUs 225, GPUs 225 can be any type of specialized circuitry that can manipulate and alter memory (e.g., graphic memory 226) to provide and/or accelerate the creation of images. GPUs 225 can store images in a frame buffer (e.g. frame buffer 245) for output to a display device such as display device 224. In some embodiments, images stored in frame buffer 245 can be provided to other computing devices through network interface 218 or I/O devices 230. GPUs 225 can have a highly parallel structure optimized for processing large, parallel blocks of graphical data more efficiently than general purpose CPUs 220. Furthermore, the functionality of GPUs 225 can be included in a chipset of a special purpose processing unit or a co-processor.

CPUs 220 can execute programming instructions stored in system memory 221 or other memory, operate on data stored in memory (e.g., system memory 221) and communicate with GPUs 225 through the system interface 250, which bridges communication between the various components of computing device 200. In some embodiments, CPUs 220, GPUs 225, system interface 250, or any combination thereof, are integrated into a single chipset or processing unit. GPUs 225 can execute sets of instructions stored in memory (e.g., system memory 221), to manipulate graphical data stored in system memory 221 or graphic memory 226. For example, CPUs 220 can provide instructions to GPUs 225, and GPUs 225 can process the instructions to render graphics data stored in the graphic memory 226. Graphic memory 226 can be any memory space accessible by GPUs 225, including local memory, system memory, on-chip memories, and hard disk. GPUs 225 can enable displaying of graphical data stored in graphic memory 226 on display device 224 or can process graphical information and provide that information to connected devices through network interface 218 or I/O devices 230.

Computing device 200 can include display device 224 and input/output (I/O) devices 230 (e.g., a keyboard, a mouse, or a pointing device) connected to I/O controller 223. I/O controller 223 can communicate with the other components of computing device 200 via system interface 250. It is appreciated that CPUs 220 can also communicate with system memory 221 and other devices in manners other than through system interface 250, such as through serial communication or direct point-to-point communication. Similarly, GPUs 225 can communicate with graphic memory 226 and other devices in ways other than system interface 250. In addition to receiving input, CPUs 220 can provide output via I/O devices 230 (e.g., through a printer, speakers, or other output devices).

Furthermore, computing device 200 can include a network interface 218 to interface to a LAN, WAN, MAN, or the Internet through a variety of connections including, but not limited to, standard telephone lines, LAN or WAN links (e.g., 802.21, T1, T3, 56 kb, X.25), broadband connections (e.g., ISDN, Frame Relay, ATM), wireless connections (e.g., those conforming to, among others, the 802.11a, 802.11b, 802.11b/g/n, 802.11ac, Bluetooth, Bluetooth LTE, 3GPP, or WiMax standards), or some combination of any or all of the above. Network interface 218 can comprise a built-in network adapter, network interface card, PCMCIA network card, card bus network adapter, wireless network adapter, USB network adapter, modem or any other device suitable for interfacing computing device 200 to any type of network capable of communication and performing the operations described herein.

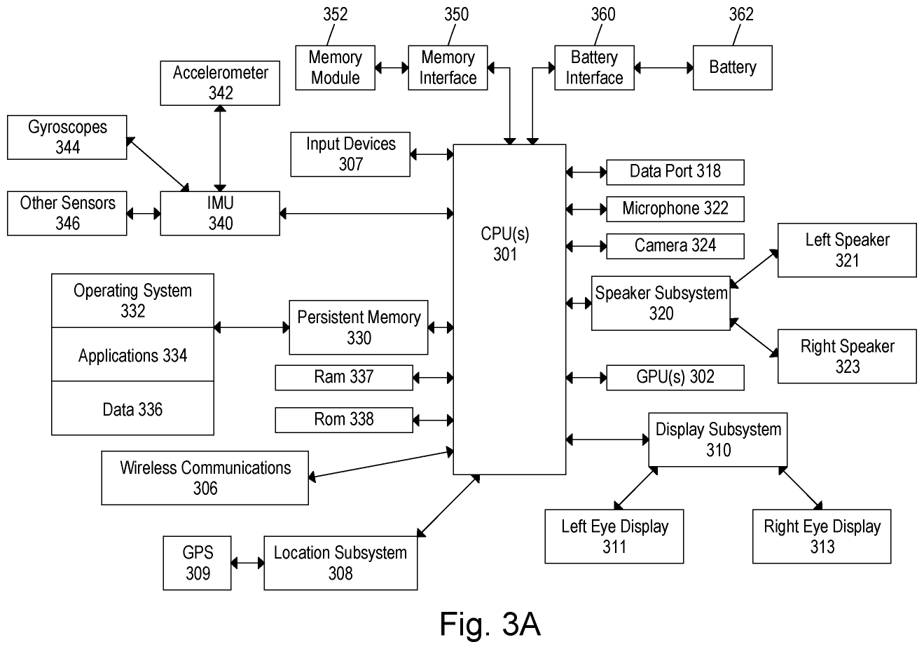

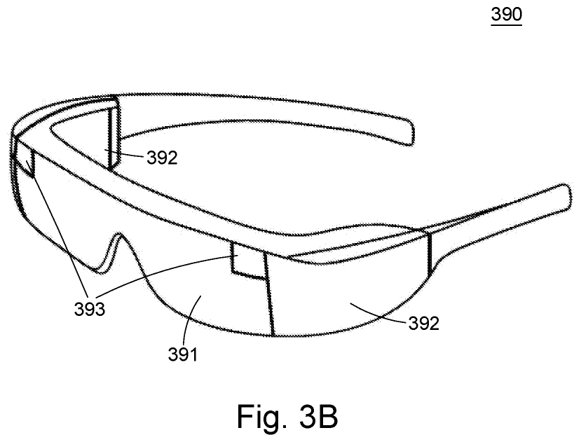

Referring back to FIG. 1, system 100 can further include user device 110. User device 110 may be an augmented reality device. Augmented reality device can be a device such as augmented reality device 390 depicted in FIG. 3B, described in more detail below, or some other augmented reality device. The augmented reality device 390 may, for example, be a Microsoft Hololens, Epson Moverio BT-300, Epson Moverio BT-2000, ODG R-7 or any other Smart glasses with network connectivity or AR-capable mobile phones, such as the Samsung Galaxy S8, or other AR-capable mobile computing device. Moreover, augmented reality device can be implemented using the components shown in device 300 illustrated in FIG. 3A and described in more detail below.

FIGS. 3A-3B are diagrams of exemplary augmented reality devices 300 and 390, consistent with embodiments of the present disclosure. These exemplary augmented reality devices can represent the internal components (e.g., as shown in FIG. 3A) of an augmented reality device and the external components (e.g., as show in FIG. 3B) of an augmented reality device. In some embodiments, FIG. 3A can represent an exemplary electronic device 300 contained within augmented reality device 390 of FIG. 3B.

FIG. 3A is a simplified block diagram illustrating an example electronic device 300. Electronic device 300 includes an augmented reality capability having video display capabilities and the capability to communicate with other computer systems, for example, via the Internet.

Electronic device 300 can include a case (not shown) housing component of electronic device 300. The internal components of electronic device 300 can, for example, be constructed on a printed circuit board (PCB). Although the components and subsystems of electronic device 300 can be realized as discrete elements, the functions of the components and subsystems can also be realized by integrating, combining, or packaging one or more elements together in one or more combinations.

Electronic device 300 can include a controller comprising one or more CPU(s) 301, which controls the overall operation of electronic device 300. CPU(s) 301 can be one or more microprocessors, field programmable gate arrays (FPGAs), digital signal processors (DSPs), or any combination thereof capable of executing particular sets of instructions. CPU(s) 301 can interact with device subsystems such as a wireless communication system 306 for exchanging radio frequency signals with a wireless network to perform communication functions, audio subsystem 320 for producing audio, location subsystem 308 for acquiring location information, and display subsystem 310 for producing display elements.

CPU(s) 301 can also interact with input devices 307, a persistent memory 330, a random access memory (RAM) 337, a read only memory (ROM) 338, a data port 318 (e.g., a conventional serial data port, a Universal Serial Bus (USB) data port, a 30-pin data port, a Lightning data port, or a High-Definition Multimedia Interface (HDMI) data port), a microphone 322, camera 324, and wireless communications 306 (which can employ any appropriate wireless (e.g. RF), optical, or other short range communications technology (for example, Wi-Fi, Bluetooth or NFC)). Some of the subsystems shown in FIG. 3A perform communication-related functions, whereas other subsystems can provide “resident” or on-device functions.

Wireless communications 306 includes communication systems for communicating with a network to enable communication with any external devices (e.g., a server, not shown). The particular design of wireless communications 306 depends on the wireless network in which electronic device 300 is intended to operate. Electronic device 300 can send and receive communication signals over the wireless network after the required network registration or activation procedures have been completed.

Location subsystem 308 can provide various systems such as global positioning system (e.g., GPS 309) that provide location information. Additionally, location subsystem can utilize location information from connected devices (e.g., connected through wireless communications 306) to further provide location data. The location information provided by location subsystem 308 can be stored in, for example, persistent memory 330, and used by applications 334 and operating system 332.

Display subsystem 310 can control various displays (e.g., left eye display 311 and right eye display 313). In order to provide an augmented reality display, display subsystem 310 can provide for the display of graphical elements (e.g., those generated using GPU(s) 302) on transparent displays. In other embodiments, the display generated on left eye display 311 and right eye display 313 can include an image captured from camera 324 and reproduced with overlaid graphical elements. Moreover, display subsystem 310 can display different overlays on left eye display 311 and right eye display 313 to show different elements or to provide a simulation of depth or perspective.

Camera 324 can be a CMOS camera, a CCD camera, or any other type of camera capable of capturing and outputting compressed or uncompressed image data such as still images or video image data. In some embodiments electronic device 300 can include more than one camera, allowing the user to switch, from one camera to another, or to overlay image data captured by one camera on top of image data captured by another camera. Image data output from camera 324 can be stored in, for example, an image buffer, which can be a temporary buffer residing in RAM 337, or a permanent buffer residing in ROM 338 or persistent memory 330. The image buffer can be, for example, a first-in first-out (FIFO) buffer. In some embodiments the image buffer can be provided directly to GPU(s) 302 and display subsystem 310 for display on left eye display 311 and/or right eye display 313 with or without a graphical overlay.

Electronic device can include an inertial measurement unit (e.g., IMU 340) for measuring motion and orientation data associated with electronic device 300. IMU 340 can utilize accelerometer 342, gyroscopes 344, and other sensors 346 to capture specific force, angular rate, magnetic fields, and biometric information for use by electronic device 300. The data capture by IMU 340 and the associated sensors (e.g., accelerometer 342, gyroscopes 344, and other sensors 346) can be stored in memory such as persistent memory 330 or RAM 337 and used by applications 334 and operating system 332. The data gathered through IMU 340 and its associated sensors can also be provided to networked devices through, for example, wireless communications 306.

CPU(s) 301 can be one or more processors that operate under stored program control and executes software modules stored in a tangibly-embodied non-transitory computer-readable storage medium such as persistent memory 330, which can be a register, a processor cache, a Random Access Memory (RAM), a flexible disk, a hard disk, a CD-ROM (compact disk-read only memory), and MO (magneto-optical), a DVD-ROM (digital versatile disk-read only memory), a DVD RAM (digital versatile disk-random access memory), or other semiconductor memories.

Software modules can also be stored in a computer-readable storage medium such as ROM 338, or any appropriate persistent memory technology, including EEPROM, EAROM, FLASH. These computer-readable storage mediums store computer-readable instructions for execution by CPU(s) 301 to perform a variety of functions on electronic device 300. Alternatively, functions and methods can also be implemented in hardware components or combinations of hardware and software such as, for example, ASICs and/or special purpose computers.

The software modules can include operating system software 332, used to control operation of electronic device 300. Additionally, the software modules can include software applications 334 for providing additional functionality to electronic device 300. For example, software applications 334 can include applications designed to interface with systems like system 100 above. Applications 334 can provide specific functionality to allow electronic device 300 to interface with different data systems and to provide enhanced functionality and visual augmentation.

Each of software applications 334 can include layout information defining the placement of particular fields and graphic elements intended for display on the augmented reality display (e.g., through display subsystem 310) according to that corresponding application. In some embodiments, software applications 334 are software modules executing under the direction of operating system 332.

Operating system 332 can provide a number of application protocol interfaces (APIs) providing an interface for communicating between the various subsystems and services of electronic device 300, and software applications 334. For example, operating system software 332 provides a graphics API to applications that need to create graphical elements for display on electronic device 300. Accessing the user interface API can provide the application with the functionality to create and manage augmented interface controls, such as overlays; receive input via camera 324, microphone 322, or input device 307; and other functionality intended for display through display subsystem 310. Furthermore, a camera service API can allow for the capture of video through camera 324 for purposes of capturing image data such as an image or video data that can be processed and used for providing augmentation through display subsystem 310.

In some embodiments, the components of electronic device 300 can be used together to provide input from the user to electronic device 300. For example, display subsystem 310 can include interactive controls on left eye display 311 and right eye display 313. As part of the augmented display, these controls can appear in front of the user of electronic device 300. Using camera 324, electronic device 300 can detect when a user selects one of the controls displayed on the augmented reality device. The user can select a control by making a particular gesture or movement captured by the camera, touching the area of space where display subsystem 310 displays the virtual control on the augmented view, or by physically touching an input device 307 on electronic device 300. This input can be processed by electronic device 300.

In some embodiments, persistent memory 330 stores data 336, including data specific to a user of electronic device 300, such as information of user accounts or device specific identifiers. Persistent memory 330 can also store data relating to those (e.g., contents, notifications, and messages) obtained from services accessed by electronic device 300. Persistent memory 330 can further store data relating to various applications with preferences of the particular user of, for example, electronic device 300, data relating to detecting unique identification marks or objects such as luggage, data relating to an object or to a set of objects being searched for, data related to previously detected objects currently or previously in the field of view of the AR device. In some embodiments, persistent memory 330 can store data 336 linking a user's data with a particular field of data in an application, such as for automatically providing a user's credentials to an application executing on electronic device 300. Furthermore, in various embodiments, data 336 can also include service data comprising information required by electronic device 300 to establish and maintain communication with a network.

In some embodiments, electronic device 300 can also include one or more removable memory modules 352 (e.g., FLASH memory) and a memory interface 350. Removable memory module 352 can store information used to identify or authenticate a user or the user's account to a wireless network. For example, in conjunction with certain types of wireless networks, including GSM and successor networks, removable memory module 352 is referred to as a Subscriber Identity Module (SIM). Memory module 352 can be inserted in or coupled to memory module interface 350 of electronic device 300 in order to operate in conjunction with the wireless network.

Electronic device 300 can also include a battery 362, which furnishes energy for operating electronic device 300. Battery 362 can be coupled to the electrical circuitry of electronic device 300 through a battery interface 360, which can manage such functions as charging battery 362 from an external power source (not shown) and the distribution of energy to various loads within or coupled to electronic device 300.

A set of applications that control basic device operations, including data and possibly voice communication applications, can be installed on electronic device 300 during or after manufacture. Additional applications or upgrades to operating system software 332 or software applications 334 can also be loaded onto electronic device 300 through data port 318, wireless communications 306, memory module 352, or other suitable system. The downloaded programs or code modules can be permanently installed, for example, written into the persistent memory 330, or written into and executed from RAM 337 for execution by CPU(s) 301 at runtime.

FIG. 3B is an augmented reality device 390. In some embodiments, augmented reality device 390 can be contacts, glasses, goggles, headgear or mobile phone or computing device that provides an augmented viewport for the wearer. As shown in FIG. 3B, augmented reality device 390 can include a viewport 391 that the wearer can look through. Augmented reality device 390 can also include processing components 392. Processing components 392 can be contained in an enclosure that house the circuitry and modules described above in relation to FIG. 3A. Although shown as two distinct elements on each side of augmented reality device 390, the processing hardware and/or components can be housed in only one side of augmented reality device 390. The components shown in FIG. 3A can be included in any part of augmented reality device 390 or may only be partly incorporated within the augmented reality device 390, with other components being provided in one or more different enclosures that are in communicative connection with the augmented reality device 390.

In some embodiments, augmented reality device 390 can include display devices 393. These display devices can be associated with left eye display 311 and right eye display 313 of FIG. 3A. In these embodiments, display devices 393 can receive the appropriate display information from left eye display 311, right eye display 313, and display subsystem 310, and project or display the appropriate overlay onto viewport 391. Through this process, augmented display device 390 can provide augmented graphical elements to be shown in the wearer's field of view. Although not shown in FIG. 3B, the camera 324 shown in FIG. 3A or multiple cameras may form part of the augmented reality device 390 or may, alternatively be provided as a separate component that is in communicative connection with the augmented reality device 390.

Referring back to FIG. 1, each of the above described components of system 100, including the individual databases, data source, data system, API, and user device 110 can be a module, which is a packaged functional hardware unit designed for use with other components or a part of a program that performs a particular function of related functions. Each of these modules can be implemented using computing device 200 of FIG. 2. In some embodiments, the functionality of system 100 can be split across multiple computing devices (e.g., multiple devices similar to computing device 200) to allow for distributed processing of the data. In these embodiments the different components can communicate over I/O device 230 or network interface 218 of FIG. 2's computing device 200.

Data can be made available to system 100 through proprietary data sources and external data sources. It is appreciated that the data sources mentioned above are not exhaustive. Many different data sources and types of data can exist in both proprietary data sources and external data sources. Moreover, some of the data can overlap among external and proprietary data sources. For example, external data sources can provide location data, which can include data about the location of specific pieces of luggage. This same data can also be included, in the same or a different form, in a proprietary data source.

Moreover any of the data sources in proprietary data sources and external data sources, or any other data sources used by system 100, can be a Relational Database Management System (RDBMS) (e.g., Oracle Database, Microsoft SQL Server, MySQL, PostgreSQL, and/or IBM DB2). An RDBMS can be designed to efficiently return data for an entire row, or record, in as few operations as possible. An RDBMS can store data by serializing each row of data. For example, in an RDBMS, data associated with a record can be stored serially such that data associated with all categories of the record can be accessed in one operation. Moreover, an RDBMS can efficiently allow access of related records stored in disparate tables by joining the records on common fields or attributes.

In some embodiments, any of the data sources in proprietary data sources and external data sources, or any other data sources used by system 100, can be a non-relational database system (NRDBMS) (e.g., XML, Cassandra, CouchDB, MongoDB, Oracle NoSQL Database, FoundationDB, and/or Redis). A non-relational database system can store data using a variety of data structures such as, among others, a key-value store, a document store, a graph, and a tuple store. For example, a non-relational database using a document store could combine all of the data associated with a particular record into a single document encoded using XML. A non-relational database can provide efficient access of an entire record and provide for effective distribution across multiple data systems.

In some embodiments, any of the data sources in proprietary data sources and external data sources, or any other data sources used by system 100, can be a graph database (e.g., Neo4j or Titan). A graph database can store data using graph concepts such as nodes, edges, and properties to represent data. Records stored in a graph database can be associated with other records based on edges that connect the various nodes. These types of databases can efficiently store complex hierarchical relationships that are difficult to model in other types of database systems.

In some embodiments, any of the data sources in proprietary data sources and external data sources, or any other data sources used by system 100, can be accessed through an API. It is appreciated that the data sources of proprietary data sources and external data sources, which can utilize, among others, any of the previously described data storage systems, can be distributed across multiple electronic devices, data storage systems, or other electronic systems.

In addition to providing access directly to data storage systems or data source, proprietary data sources 110 can include data systems. Data systems can connect to one or multiple data sources, such as database. Data systems can provide an interface to the data stored in a database. In some embodiments, data system can combine the data in a database with other data. Data systems can pre-process the data in a database before providing that data to the API or some other requestor.

Proprietary data sources may not be directly accessible or available to the public. These data sources can be provided to subscribers based on the payment of a fee or a subscription. Access to these data sources can be provided directly by the owner of the proprietary data sources or through an interface such as the API shown in FIG. 1 and described in more detail below.

A variety of proprietary data sources can be available to system 100 from a variety of providers. In some embodiments, each of the groupings of data sources will include data related to a common industry or domain. In other embodiments, the grouping of proprietary data sources can depend on the provider of the various data sources. For example, the data sources in proprietary data sources 110 can contain data related to the airline travel industry. In this example, database can contain travel profile information. In addition to basic demographic information, the travel profile data can include upcoming travel information, past travel history, traveller preferences, loyalty information, and other information related to a traveller profile.

Unlike proprietary data sources, external data sources can be accessible to the public or can be data sources that are outside of the direct control of the provider of API or system 100. Flight data can include flight information, gate information, and/or airport information that can be accessed through, among others, the FlightStats API, FlightWise API, FlightStats API and the FlightAware API. Each of these external data sources can provide additional data accessed through API.

As previously described, the API can provide a unified interface for accessing any of the data available through proprietary data sources and external data sources in a common interface. The API can be software executing on, for example, a computing device such as computing device 200 described in relation to FIG. 2. In these embodiments, the API can be written using any standard programming language (e.g., Python, Ruby, Java, C, C++, node.js, PHP, Perl, or similar) and can provide access using a variety of data transfer formats and/or protocols including, among others, SOAP, JSON objects, REST based services, XML, or similar. The API can provide receive request for data in a standard format and respond in a predictable format. In some embodiments, the API can combine data from one or more data sources (e.g., data stored in proprietary data sources, external data sources, or both) into a unified response. Additionally, in some embodiments the API can process the information from the various data sources to provide additional fields or attributes not available in the raw data. This processing can be based on one or multiple data sources and can utilize one or multiple records from each data source. For example, the API could provide aggregated or statistical information such as averages, sums, numerical ranges, or other calculable information. Moreover, the API can normalize data coming from multiple data sources into a common format. The previous description of the capabilities of the API is only exemplary. There are many additional ways in which the API can retrieve and package the data provided through proprietary data sources and external data sources.

The user device 110 can interact with the API. User device 110 may receive information from the API (e.g., through wireless communications 306 of FIG. 3). This information can include any of the information previously described in relation to FIG. 3. For example, user device may generate location information, motion information, visual information, sound information, orientation information, or any other type of information.

The user device 110 may process the generated information using its own computing resources. Alternatively some or all of the information generated may be transferred to other devices for partial or complete processing. In the latter case the user device 110 may transfer a user device ID to identify the source of the data.

Information not present on the user device 110 may be pushed to the user device via the API. For example information relating to lost luggage may be pushed to one or more or all user device associated with the system 100 to enable highlighting of the missing pieces of luggage in the user device 110 as and when the piece of luggage has been identified. Additionally or alternatively the user device 110 may pull information from the computing environment 120 via the API.

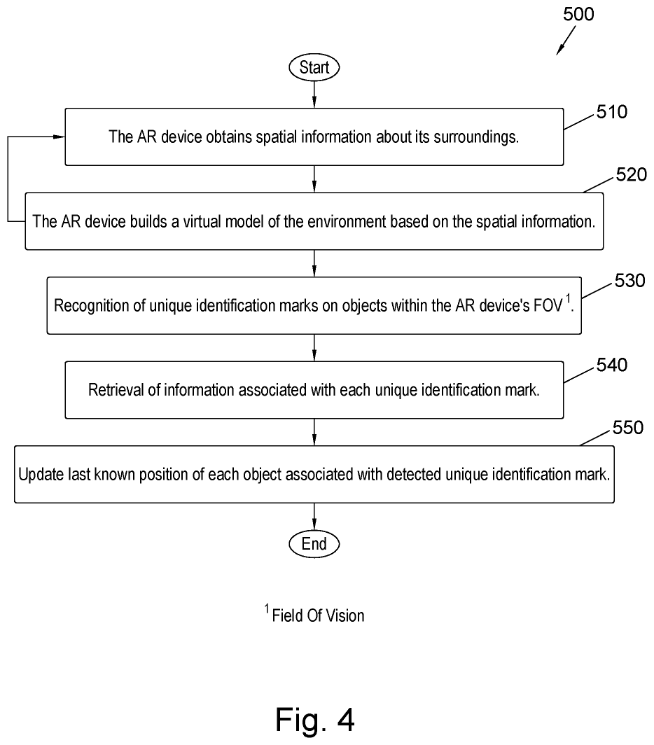

FIG. 4 is a flowchart of an exemplary method 500 for locating objects using an AR device. The AR device may be a device as described above with reference to FIGS. 3A and 3B. In an embodiment the AR device starts out by obtaining spatial information of the surroundings of the AR device's user using the sensors of the AR device in step 510. These sensors may include one or more cameras 324 or, more generally, any sensor suitable for detecting spatial properties of objects in the field of view (FOV) of the AR device. The acquired spatial information is processed by the AR device to build a virtual spatial model of the objects in the field of view of the AR device. The AR device stores processor executable instructions in persistent memory 330. These instructions include computer executable instructions for performing simultaneous localisation and mapping (SLAM), a technique for constructing a map of an unknown environment while simultaneously keeping track of an agent's location within it. A range of different SLAM algorithms are known from a variety of technical fields, including autonomous vehicles and robotic navigation, and a detailed discussion of SLAM is therefore neither included nor necessary in the present description. The processor executable code is, in use, executed by CPU 301 of the AR device in step 520, causing the AR device to generate a virtual model of the objects sensed by the sensors of the AR device. This virtual model, as is indicated by the arrow connecting steps 520 back to step 510, is continuously updated to allow changes in the physical surroundings of the AR device to be detected and included in the virtual model. Such changes in the physical surroundings may include a change in the arrangements of objects within the FOV of the AR device or simply a change in the FOV of the sensors of the AR device. Changes in the FOV of the sensors of the AR device may occur because an operative that may wear the AR device has moved or because objects within the FOV have been moved.

Objects that are being sensed by the AR device (and incorporated within the virtual model of the FOV of the AR device) may comprise a unique identifier. Such unique identities may be attached to or otherwise uniquely associated with the object. For aircraft luggage this is, at the time of writing, normally a unique 10 digit code encoded as a barcode on a tag attached to the luggage. When sensing the spatial information surrounding the AR device the relevant tags, including the codes, are sensed, in as far as they are visible, and decoded. The CPU 301 attributes the detected unique identifiers with the relevant structures of the virtual model, so that these structures of the virtual model are uniquely linked with their respective real world equivalents via the unique identifiers. As mentioned above, the virtual model is updated on an ongoing basis. This does, however, not mean that as the FOV of the sensors change so that parts of the virtual model are no longer updated (because the objects represented in the virtual model no longer reside within the FOV of the sensors) these parts of the virtual model are discarded. To the contrary, as the FOV of the sensors changes the virtual model continues to grow. Any uniquely identified objects within this virtual model is remembered as such.

Whilst the discussion above of the unique identifier focusses on the 10 digit code used in the aviation industry to identify luggage, any identifier that allows to uniquely identify an object can be used for identifying the object. Such identifiers may include QR codes, AR codes or features of the object itself that uniquely identify the object and that have been stored as a uniquely identifying feature of the object at an earlier stage, say at check in of the object into the luggage handling systems of the carrier. Such unique identifying features may include unique marks on luggage that have been scanned or photographed at check in.

It will be appreciated that, whilst the above description has focussed on the AR device storing the computer executable code that causes the CPU of the AR device, upon execution, to perform simultaneous localisation and mapping, it is not essential that all of these operations are performed on the AR device itself. It is equally possible for sensed location data to be uploaded to another computing device for SLAM processing on the other computing device. This may allow more detailed or faster computation of the virtual model, albeit at the cost of increased data transfer from the device comprising the sensors to the other computing device. Any suitable type of other computing device may be used be it a physical device, a group or network of physical devices or virtual computing resources, or a combination thereof.

Once an object has been uniquely identified the AR device interfaces with databases storing information relating to the object in step 540 and downloads information relating to the object. This step may be omitted if the AR device does not require any information relating to objects, say, for example, in situations in which the purpose of creating the virtual map of is to simply search for certain objects and to upload location information of these objects determined during the search to the database.

In some embodiments the information relating to uniquely identified objects is required by the AR device and, in these embodiments, is downloaded to the AR device from the databases. In step 550 information relating to uniquely identified object is uploaded to the database. This information includes the unique identifier of the object and its location within the virtual model to provide the database with information of the absolute location of the object or information that allows translating the information of the absolute location of the object within the virtual model into information of the absolute location of the object within the real world. Additionally context or use-case information may be uploaded from the AR device to the database. Alternatively or additionally context or use-case information may be inferred by the server or uploaded context or use-case information may be supplemented by further information inferred by the server. For example, an observation by the AR device that an identified object, such as an identified piece of luggage, has been placed in another object, such as a container, may be used by the server to infer that the object has been loaded. The current position of the object can then be inferred through reference to the current position of the object/container within which it had been placed, even though the object that had been placed within the other object/container may be obscured from observation by the AR device following the placement. Knowledge of movement of the larger object/container onto an aircraft can further be used to infer that all objects known to be within the larger object/container have been loaded onto the aircraft.

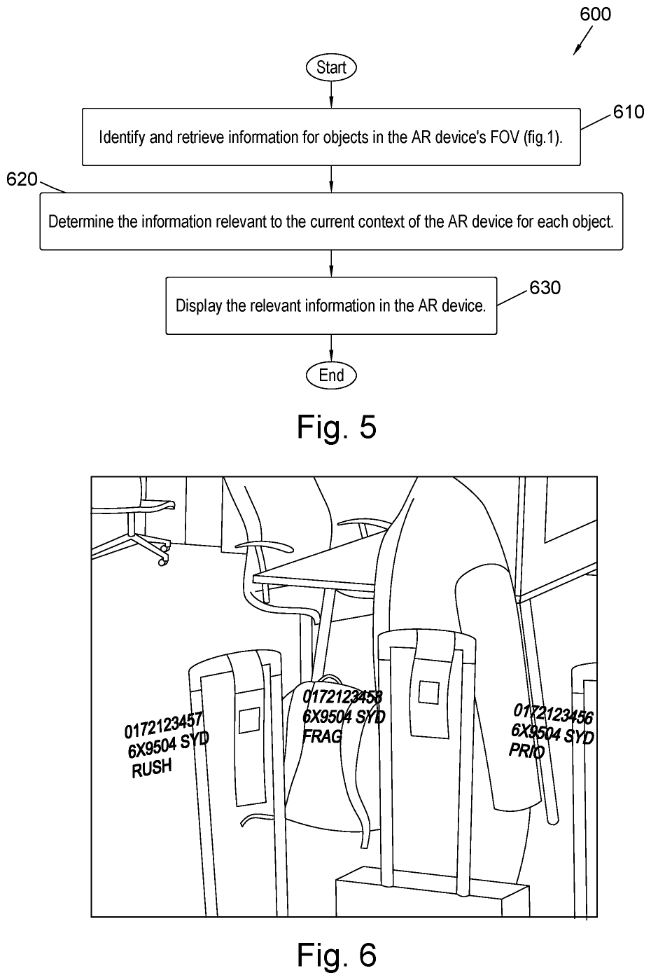

The information downloaded to the AR device may be displayed to the user of the AR device by being overlaid over the field of view seen by the user of the AR device. A method 600 of displaying information is illustrated in FIG. 5. In step 610 objects within the FOV of the AR device are identified and information relating to the identified objects is downloaded to the AR device. One method of identifying objects and downloading related information is the method described above with reference to FIG. 4. In step 620 information relevant to the current context of the AR device for each object is determined. This includes, without limitation, determining whether or not an object for which information has been downloaded is still within the FOV of the AR device (and, consequently, if the information can sensibly be displayed at all), determining whether the downloaded information is relevant to the current operating mode or operating criteria of the AR device. If the user of the AR device has, for example, indicated that he or she wants to find lost luggage, then only information relating to luggage that has been indicated in the downloaded information as relating to luggage that is to be found is determined relevant to the current context of the AR device. Equally, if the AR device is to aid loading of luggage that fulfils a particular criterion (say, the luggage has been classified for rush processing) then only information matching this criterion is determined as relevant to the current context of the AR device. The thus selected information is then displayed on the AR device in a manner that it is superimposed over the AR device user's view of the object in question.

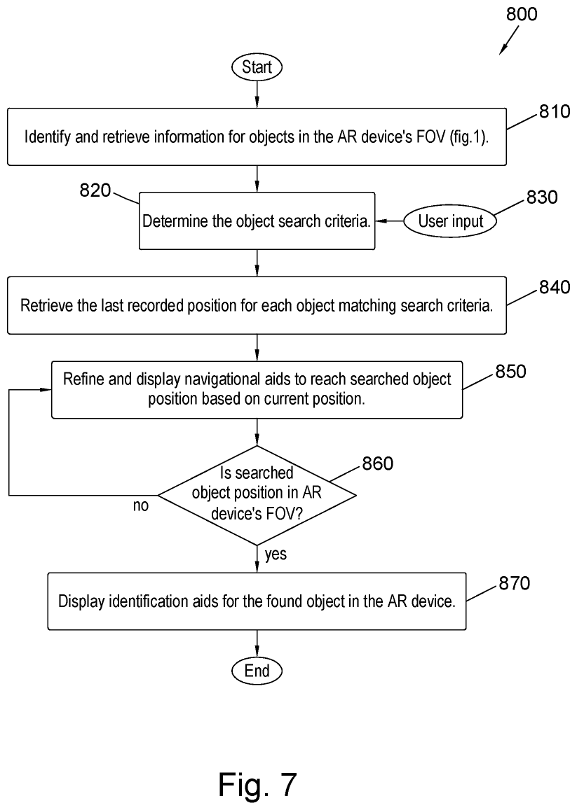

An example of a display presented to a user of an AR device is shown in FIG. 6. There the view the user of the AR device has of his or her surroundings through the AR device is overlaid with information relating to the identified object. In the example shown this information includes a representation of the unique identifier, details of the flight on which the piece of luggage has been or is to be transported and an indication of the manner in which the piece of luggage is to be handled, in particular a rating indicating the urgency with which the object is to be handled. The displayed information can additionally or alternatively include the class associated with the piece of luggage, luggage handling priority, luggage weight, information regarding a connection flight on which the piece of luggage is to be transported and/or information relating to the current status of the piece of luggage. Information relating to the current status of the piece of luggage can include information indicating if the piece of luggage is lost, has been correctly or incorrectly loaded or if the piece of luggage must be offloaded, say because the passenger has failed to board the plane. Augmented view can be a view through viewport 391 from FIG. 3B and can be the result of the display device from 393 from FIG. 3B projecting graphical overlays provided by left eye display 311 and right eye display 313 of display subsystem 310 of FIG. 3A. Augmented view can represent graphical overlays on viewport 391 resulting in the augmented reality view.

FIG. 7 illustrates a method 800 of searching for objects that uses the method 500 discussed above with reference to FIG. 4 in step 810 to generate and/or update a virtual model of the environment of the user of an AR device and to download information of objects identified within the FOV of the AR device's sensors. It will be appreciated that, whilst this step if shown as a discrete step 810 that forms part of the method 800 in an embodiment step 810/method 500 is performed continuously as one processing task alongside the other method steps to ensure that the virtual representation of the environment in which the user currently operates remains up-to-date. In situations where a large number of objects are present within the AR device's sensor FOV it may be difficult to display all information related to these objects to the user of the AR device in a clear fashion. To enhance the clarity of the displayed information the embodiments allows for filtering of the information based on search or filtering criteria. These criteria are determined in step 820. This may be done based on user input, as indicated in step 830. The user may, in particular, input explicit instructions regarding the type of object he or she wishes to have identified. Such search criteria may be very specific and can, for example relate to luggage that ought to be loaded onto specific flights or luggage that needs to be handled with a predetermined degree of urgency, say bags that need to be made subject of rush processing. Alternatively or additionally the search criteria may be specific to a particular object, say to a specific piece of luggage that has been lost.

Alternatively or additionally the user may provide input or may be presented with a choice of inputs for selection thereof. The user may, for example, provide user input that indicates that the device is to be operated in a particular mode. In one embodiment the device will present a number of modes from which a user can choose. One such mode can, for example, be the baseline input mode in which a 3D map of the area being surveyed is created, such as the mode/method 500 described above with reference to FIG. 5, a search mode, a mode in which an aircraft or container is loaded or unloaded, etc.

The user input may be provided in a number of different ways. The present disclosure is not limited to a particular way or to particular ways of inputting user information. In one embodiment user input may be input at the AR device itself, say through input devices 307. In one embodiment the input devices 307 include means for displaying a menu of search criteria options available to the user.

In step 840 the last recorded position of objects that match the search criteria are retrieved. This information may be retrieved from a server or, if the relevant information is already present in the AR device, alternatively form the memory of the AR device. This information may be available from a process previously performed in using the AR device in which a virtual representation of the surroundings of the AR device has already been created and objects within the representation have been identified. Alternatively or additionally the last known position of the object is retrieved from a server for referencing within the virtual representation that has been created by the AR device or that is being created by the AR device. In an embodiment the user may orientate the AR device so that a unique identifier that is fixedly installed within an environment is within its field of view. By detecting the identifier a fixed real world reference point is determined. The AR device or computing equipment in communicative connection with the AR device uses such a detected unique identifier to calculate an absolute position of the virtual representation that the user's environment occupies in the real world. On the basis of the spatial connection between the virtual representation of the user's environment and the real world routing information can be displayed to the user through/by the AR device, for example for guiding the user towards a last known location of an object. More generally, once an absolute position is determined by, for example, reading a QR-code on a wall, then any co-ordinate relative to the AR-device can be translated to an absolute co-ordinate. It will be appreciated that different types of unique identifiers can be used for this purpose, that individual AR devices may be configured to identify different types of identifiers, as needed, and that different AR devices can use different types or the same type of identifier to determine an absolute reference point for the generated 3D models. It will be appreciated that the unique identifier does not need to always remain in the FOV as the AR device is configured in the embodiment, to translate coordinates that are part of the virtual representation of the environment into absolute/real-world coordinates, for example using SLAM (Simultaneous Localisation And Mapping).

Once the last known position of an object that is to be searched for has been retrieved by the AR device a determination of whether or not the object is within the current FOV of the AR device is made by identifying objects that are within the FOV of the AR device based on unique identifiers carried by the objects and detected and by the AR device and by correlating the identified unique identifiers with the unique identifier of the object that is being searched for. The current FOV of the AR device is the FOV over which the AR device and/or associated computing equipment can currently create a virtual representation of the environment. Should the current object not be within the current FOV of the AR device, then routes within the virtual model are determined. Those parts of the relevant route(s) that are within the FOV of the AR device are displayed within the AR device in step 850 to allow the user of the AR device to move closer to the object that is to be found. The route may be calculated by a computing device the AR device in communicative connection with. In one embodiment the route is calculated using a geographical information system (GIS) that operates on the computing system and that determines the route on the basis of a map of the local environment in question. The local map may be generated in a known manner, for example using mapping tools provided by ESRI (www.esri.com) and coordinates within the “real world” map are correlated with coordinates within the virtual representation of the environment. Either or both of these coordinates may alternatively or additionally be correlated to geographical or map data, such as googlemaps. Techniques for navigating through the map of the local environment are the same as those used for navigating on a larger scale, such as those used in googlemaps.

The display of the sections of the route is constantly updated to correct/allow for movement of the user of the AR device and for the consequent continuous changes of the FOV of the AR device. The process of refining and displaying navigational aids of step 850 is repeated until it is determined in step 860 that the object that is to be found has entered the FOV of the AR device. When the object to be found is within the FOV of the AR device information relating to the object and identifying the object as the object that is to be found is displayed in step 870 to the user by the AR device. This display step may use the method discussed above with reference to FIG. 5.

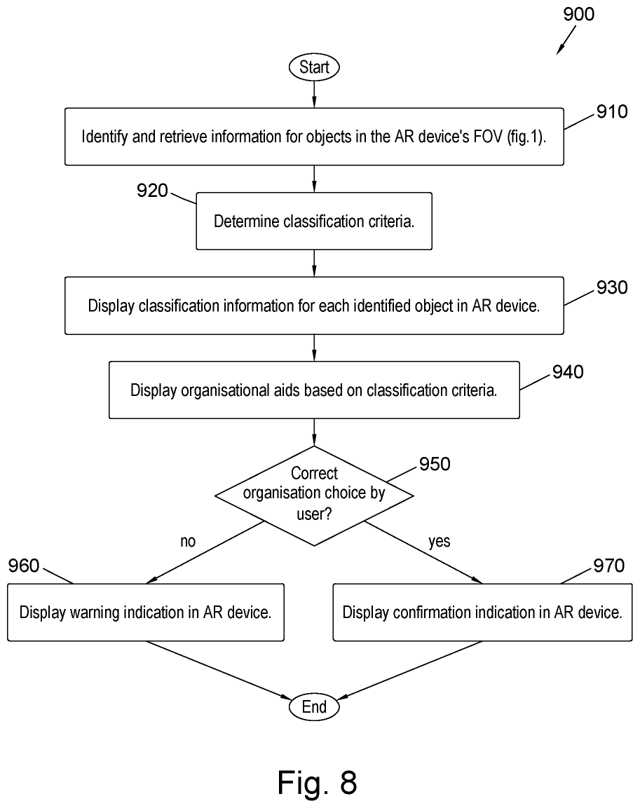

FIG. 8 illustrates a method 900 in which an AR device is used in aiding handling of objects. In step 910 a virtual representation of the environment in which the AR device is located is generated. This may be done using the method discussed above with reference to FIG. 4. Information relating to objects within the virtual model that have been identified is moreover retrieved. As discussed above with regard to the search process, such retrieval may be from memory of the AR device itself or from a server in communicative connection with the AR device. In step 920 the classification criteria are determined and classification information based on the determined classification criteria is displayed in the AR device in step 930 in a manner so that the information overlays the current view(s) of the identified object(s). The information can be displayed in the manner discussed above with reference to FIG. 5. Classification criteria are attributes, physical or otherwise, that characterise the handled objects (luggage, for example). Examples of classification criteria are: dimensions, volume, weight, priority, class, colour or any other attribute that has a functional significance in the context in which method 900 is used. The classification criteria can be determined in step 920 by user input, or may, alternatively be predetermined for the specific context in which the user of the AR device presently operates. For example, baggage loading classification criteria may include priority, flight details, class, weight, etc.

In step 940 organisational aids are displayed to the user of the AR device, for example to a baggage handler using the AR device. Organisational aids may be information that allows the user of the AR device to place objects identified or associated with the organisational aids in the manner indicated by the organisational aid. An organisation aid may, for example, indicate to the user of the AR device that the object associated with the organisational aid is to be placed in a particular location indicated by the organisational aid. It may, for example, be indicated by the organisational aid that a particular piece of luggage identified in the virtual model should be placed in a given luggage container.

As the user of the AR device handles the object the AR device updates the virtual model it creates of its surroundings and determines, in step 950, if the handled object has been handled in accordance with the directions given by the organisational aid. Should this not be the case, then a warning is displayed to the user in step 960. If the object has been handled correctly then confirmation to this effect is displayed in step 970.

Although the previous systems are described in terms of an airport context, the system can be used for many different domains. The features used and data that is incorporated can be based on the specific domain in which the disclosed embodiments are deployed.

Further embodiments of the invention are set out in the following clauses:

1. A method of determining the location of uniquely identifiable objects performed by an augmented reality computing system, hereinafter referred to as AR system, that includes one or more processors, the method comprising:

generating a three dimensional virtual model of at least a part of an environment surrounding the AR system based on information provided by sensors of the AR system;

detecting a unique identifier of an object within the environment using said sensors; and

determining a location of the object within the three dimensional model.

2. A method according to Clause 1, wherein the method further comprises:

detecting an identifier that has a known absolute position within the environment surrounding the AR system and referencing the positions of objects within the virtual model, thereby associating an absolute real world position to the objects.

3. A method according to Clause 1, further comprising:

retrieving stored information relating to a uniquely identified object and displaying at least part of the stored information in a user observable display portion of the AR system.

4. A method according to Clause 3, wherein the method further comprises:

when the object is not within the FOV of the AR system as observable by the user of the AR system, determining a route within the virtual model that allows the user of the AR system to move toward the object and displaying the route within the FOV of the AR system as observable by the user of the AR system.

5. A method of displaying object information performed by an augmented reality computing device, hereinafter referred to as the AR device, that includes one or more processors, the method comprising:

receiving information relating to a moveable object;

checking whether a virtual representation of the object forms part of a virtual representation of the environment occupied by the AR device; and

displaying, in a user observable display portion of the AR device information relating to the object.

6. A method according to Clause 5, wherein the method further comprises:

when the object is not within the FOV of the AR system as observable by the user of the AR device, determining a route within the virtual model that allows the user of the AR device to move toward the object and displaying the route within the FOV of the AR device as observable by the user of the AR device.

7. A method according to Clause 5, wherein the method further comprises:

receiving said indication by one or more of:

detecting and interpreting a voice command provided by the user;

detecting and interpreting one or more user gestures using sensors of the AR device; or

detecting and interpreting a region of a display of the AR device or an object currently observed by the user of the AR device.

8. A communication method performed by a computer system, the method comprising:

transmitting, to one or more AR devices that are in communicative connection with the computing system, information relating to an object, wherein the information comprises a unique object identifier and object handling information.

9. A method according to Clause 8, wherein further comprising:

determining, based on information stored in the computing system, a last known location of the object;

selectively transmitting said information only to one or more of the one or more AR devices that are known to be in a vicinity of the last known location of the object.

10. A method according to Clause 9, wherein the method further comprises:

receiving, from an AR device location information of a uniquely identifiable object; and one or more of:

storing said location information in a memory device of the system; or

forwarding said information or part thereof to one or more other AR devices of the one or more AR devices.

11. A non-transitory computer readable storage medium storing instructions that are executable by an augmented reality computing system that includes one or more processors to cause the system to perform a method according to any of the preceding clauses.

12. An augmented reality computing system, hereinafter referred to as AR system, comprising one or more processors configured to determine the location of uniquely identifiable objects by:

generating a three dimensional virtual model of at least a part of an environment surrounding the AR system based on information provided by sensors of the AR system;

detecting a unique identifier of an object within the environment using said sensors:

determining a location of the object within the three dimensional model.

13. An augmented reality computing device, hereinafter referred to as the AR device, comprising one or more processors configured to:

receive information relating to a moveable object;

check whether a virtual representation of the object forms part of a virtual representation of the environment occupied by the AR device; and

display, in a user observable display portion of the AR device information relating to the object.

14. An AR device according to Clause 13, further configured to:

receive an indication from a user of the AR device of an operating mode or one or more information selection criteria; and

operate the AR device in an operating mode identified by a received indication or filter the received information according to a received indication of the one or more information selection criteria.

15. A computing system comprising one or more processors configured to:

transmit, to one or more AR devices that are in communicative connection with the computing system, information relating to an object, wherein the information comprises a unique object identifier and object handling information

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

1. A method of determining the location of uniquely identifiable objects performed by an augmented reality computing system, hereinafter referred to as AR system, that includes one or more processors and sensors, the method comprising:
generating a three dimensional virtual model of at least a part of an environment surrounding the AR system based on information provided by sensors of the AR system;
detecting a unique identifier of an object within the environment using said sensors; and
determining a location of the object within the three dimensional model.

2. A method as claimed in claim 1, wherein the method further comprises:
detecting an identifier that has a known absolute position within the environment surrounding the AR system and referencing the positions of objects within the virtual model, thereby associating an absolute real world position to the objects.

3. A method as claimed in claim 1, further comprising:
retrieving stored information relating to a uniquely identified object and displaying at least part of the stored information in a user observable display portion of the AR system.

4. A method as claimed in claim 3, wherein the method further comprises:
when the object is not within the Field Of Vision of the AR system as observable by the user of the AR system, determining a route within the virtual model that allows the user of the AR system to move toward the object and displaying the route within the Field Of Vision of the AR system as observable by the user of the AR system.

5. A method as claimed in claim 1, wherein the AR system comprises one or more augmented reality computing devices, hereinafter referred to as the AR devices, that includes one or more processors, the method comprising a step of displaying object information performed by an AR device, the method comprising:
receiving information relating to a moveable object;
checking whether a virtual representation of the object forms part of a virtual representation of the environment occupied by the AR device; and
displaying, in a user observable display portion of the AR device information relating to the object.

6. A method as claimed in claim 5, wherein the method further comprises:
when the object is not within the Field Of Vision of the AR system as observable by the user of the AR device, determining a route within the virtual model that allows the user of the AR device to move toward the object and displaying the route within the Field Of Vision of the AR device as observable by the user of the AR device.

7. A method as claimed in claim 5, wherein the method further comprises:
receiving said indication by one or more of:
detecting and interpreting a voice command provided by the user;
detecting and interpreting one or more user gestures using sensors of the AR device; or
detecting and interpreting a region of a display of the AR device or an object currently observed by the user of the AR device.

8. A method according to claim 1, wherein the AR system comprises one or more augmented reality computing devices, hereinafter referred to as the AR devices, the method comprising a communication step performed by a computer system, the communication step comprising:
transmitting, to one or more AR devices that are in communicative connection with the computing system, information relating to the object, wherein the information comprises a unique object identifier and object handling information.

9. A method as claimed in claim 8, wherein the method further comprises:
determining, based on information stored in the computing system, a last known location of the object;
selectively transmitting said information only to one or more of the one or more AR devices that are known to be in a vicinity of the last known location of the object.

10. A method as claimed in claim 8, wherein the method further comprises:
receiving, from an AR device location information of a uniquely identifiable object; and one or more of:
storing said location information in a memory device of the system; or
forwarding said information or part thereof to one or more other AR devices of the one or more AR devices.

11. A non-transitory computer readable storage medium storing instructions that are executable by an augmented reality computing system that includes one or more processors to cause the system to perform a method as claimed in claim 1.

12. An augmented reality computing system, hereinafter referred to as AR system, comprising one or more processors configured to determine the location of uniquely identifiable objects by:
generating a three dimensional virtual model of at least a part of an environment surrounding the AR system based on information provided by sensors of the AR system;
detecting a unique identifier of an object within the environment using said sensors;
determining a location of the object within the three dimensional model.

13. An AR system as claimed in claim 12, wherein the AR system comprising one or more augmented reality computing devices, hereinafter referred to as the AR devices, a AR device being configured to:
receive information relating to a moveable object;
check whether a virtual representation of the object forms part of a virtual representation of the environment occupied by the AR device; and
display, in a user observable display portion of the AR device information relating to the object.

14. An AR system as claimed in claim 13, wherein the AR system is further configured to:
receive an indication from a user of the AR device of an operating mode or one or more information selection criteria; and
operate the AR device in an operating mode identified by a received indication or filter the received information according to a received indication of the one or more information selection criteria.

15. An AR system as claimed in claim 12, wherein the AR system comprises one or augmented reality computing devices, hereinafter referred to as the AR devices, the system being configured to:
transmit, to one or more AR devices that are in communicative connection with the system, information relating to the object, wherein the information comprises a unique object identifier and object handling information.
